(19) United States
(12) Patent Application Publication
(10) Pub. No.: US 2005/0276278 A1
(43) Pub. Date: Dec. 15, 2005

(54) System and method for intergration processing of different network protocols and multimedia traffics

(75) Inventors: Kwangmo Jung, Yongin-si (KR); Chan-Soo Yoon, Seoul (KR); Seiung-Uk Lim, Yongin-si (KR); Young-Choong Park, Seoul (KR); Kwang-Soon Choi, Incheon (KR); Kyeung-Hak Seo, Seoul (KR)

Correspondence Address: GREENBLUM & BERNSTEIN, P.L.C., 1950 ROLAND CLARKE PLACE, RESTON, VA, 20191, US

(73) Assignee: Korea Electronics Technology Institute, Gyeonggi-do (KR)

(21) Appl. No.: 10/528,188

(22) PCT Filed: Sep. 18, 2003
(86) PCT No.: PCT/KR03/01898

§ 371 Date: Mar. 17, 2005

(30) Foreign Application Priority Data
Sep. 18, 2002 (KR) 10-2002-0056725

(51) Int. Cl. H04J 3/22

(52) U.S. Cl. 370/466

(57) ABSTRACT

The present invention relates to a communication system architecture which can perform integrated processing of different network protocols and multimedia traffics. The communication system for integrated processing of different network protocols and multimedia traffics comprises a common packet; a common packet switch; a plurality of channels; a common bus; a common protocol platform; an external network protocol converter; and an internal network protocol converter. Thus, the present invention can process traffics rapidly embodied by mean of hardware, and easily perform various QoS, traffic control, and so on by designing a unified common platform with an open architecture. In addition, the present invention can be used for digital consumer devices in building networks and home networks or various digital appliances classified as Internet information appliances, and for control systems such as a home gateway, a home server, an STB, a home station and so on.

### TECHNICAL FIELD

The present invention relates to communication system architectures and, more particularly, to a communication system architecture which can perform integrated processing of different network protocols and multimedia traffics.

### BACKGROUND ART

In general, gateways perform protocol conversions at the end point of networks using different network protocols so that each device can understand data from other networks. Generally, conventional gateways have provided services based on a one-to-one protocol conversion.

Thus, for a number, n, of different protocol networks and a number, m, of other different protocol networks, there are two methods by which each network can communicate with one another. First, based on the number of networks that have to be connected, a plurality of gateways, each of which connects two networks, are used. Second, m network interfaces are established through merging gateways for one-to-one protocol conversion, and each interface has (m−1) compatible modules to transform data. Here, (m−1) means to exclude a network identical to itself from the number of the other side networks. The output of each module within each interface is connected to all of the other side networks. Accordingly, the number of compatible modules within each interface increases according to the number of network interfaces and the number of networks to be converted and outputted in each interface in order to support compatibility among various networks.

Moreover, in prior art, it was difficult to embody a multi-protocol conversion because the conversion between protocols was performed in a one-to-one way such as ADSL-Ethernet, ADSL-HomePNA, Cable-Ethernet, Cable-HomePNA, and so on. To perform the multi-protocol conversion, a circuit was designed using a plurality of chipsets embodied by the above-mentioned methods, and protocols and datagram were converted by software. In other words, datagram was stored in a memory and the datagram stored was converted into desired datagram by means of appropriate software.

However, with such conventional multi-protocol conversion method, it is difficult to process high-speed mass data in real time and impossible to convert a plurality of protocols simultaneously. In addition, another problem is high costs due to lots of additional circuits to design multi-protocol conversion circuits.

### DISCLOSURE OF INVENTION

Accordingly, the present invention is directed to a new communication system architecture, which can process different network protocols simultaneously, that substantially obviates one or more problems due to limitations and disadvantages of the related art.

An object of the present invention is to provide a communication system architecture for integrated processing of different network protocols and multimedia traffics, which can perform integrated processing on a home network having various types of networks and traffics and rapidly process mass data at the same time as performing multi-channel processing by allocating various kinds of packets to each channel and processing them on a channel-by-channel basis.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the object and other advantages and in accordance with the purpose of the invention, as embodied and broadly described herein, the present invention provides a communication system for integrated processing of different network protocols and multimedia traffics, comprising:

a common packet having a header and data to process multi-protocol;

a common packet switch for switching, bridging, and routing the common packet internally;

a plurality of channels for exchanging packets through dedicated lines according to types of packets;

a common bus for transmitting the common packet to/from the common packet switch;

a common protocol platform able to build free topology through an address translation so as to perform integrated processing of different protocols, different packet formats and so on;

an external network protocol converter for converting a packet received from a wide area network into a common packet; and

an internal network converter for converting a packet received from a local area network into a common packet.

In addition, the present invention provides a method for integrated processing of different network protocols and multimedia traffics, comprising the steps of:

converting a packet received from a wide area network into a common packet on an external network protocol converter, or converting a packet received from a local area network into a common packet on an internal network protocol converter;

switching the common packet so that they can be switched, bridged, and routed internally;

channelizing to exchange packets through dedicated lines according to types of packets;

loading the common packet on a common bus to transmit the common packet to/from a common packet switch; and

identifying a destination address of the common packet and performing an appropriate protocol conversion on a common packet platform, the common packet platform being able to build free topology through an address translation.

It is to be understood that both the foregoing general description and the following detailed description of the present invention are exemplary and explanatory and are intended to provide further explanation of the invention as claimed.

### BRIEF DESCRIPTION OF THE DRAWINGS

Further objects and advantages of the invention can be more fully understood from the following detailed description taken in conjunction with the accompanying drawings, in which:

FIG. 1 illustrates a communication system architecture designed according to the present invention;

FIG. 2 illustrates a process of transmitting packets from a WAN to a LAN;

FIG. 3 illustrates a process of transmitting packets from a LAN to a WAN;

FIG. 4 illustrates a process of transmitting packets from a LAN to another LAN;

FIG. 5 is a block diagram of a chipset embodied according to the present invention; and

FIG. 6 is an example of various network structures embodied according to the present invention.

<Reference>

```
  10: WAN protocol converter (WPC)
  20: common packet (CP)
  30: common bus (CB)
  40: common packet switch (CPS)
  50: common protocol platform (CPP)
  60: LAN protocol converter (LPC)
100: physical layer (PHY)
110: interface
120: buffer controller
130: output buffer
140: input buffer
150: buffer controller
160: traffic management
170: anything-to-CP converter
180: CP-to-anything converter
190: address table
200: controller
210: reassembly
220: segmentation
230: common packet switch (CPS)
240: common bus (CB)
250: memory controller
260: bus controller
270: scheduler
280: QoS & priority controller
290: CP packet memory
300: linked list buffer
310: QoS buffer
320: priority buffer
400: wide area network (WAN)
410: xDSL
420: cable modem
430: Ethernet
440: room 1
450: station 1
460: common packet (CP)
470: common packet switch (CPS)
480: twist pair (TP)
490: room 2
500: station 2
510: radio frequency (RF)
520: room 3
530: station 3
540: peer-to-peer
550: ring network
560: bus network
570: star network
580: power line communication (PLC)
```

### BEST MODE FOR CARRYING OUT THE INVENTION

Reference will now be made in detail to the preferred embodiments of the present invention, examples of which are illustrated in the accompanying drawings.

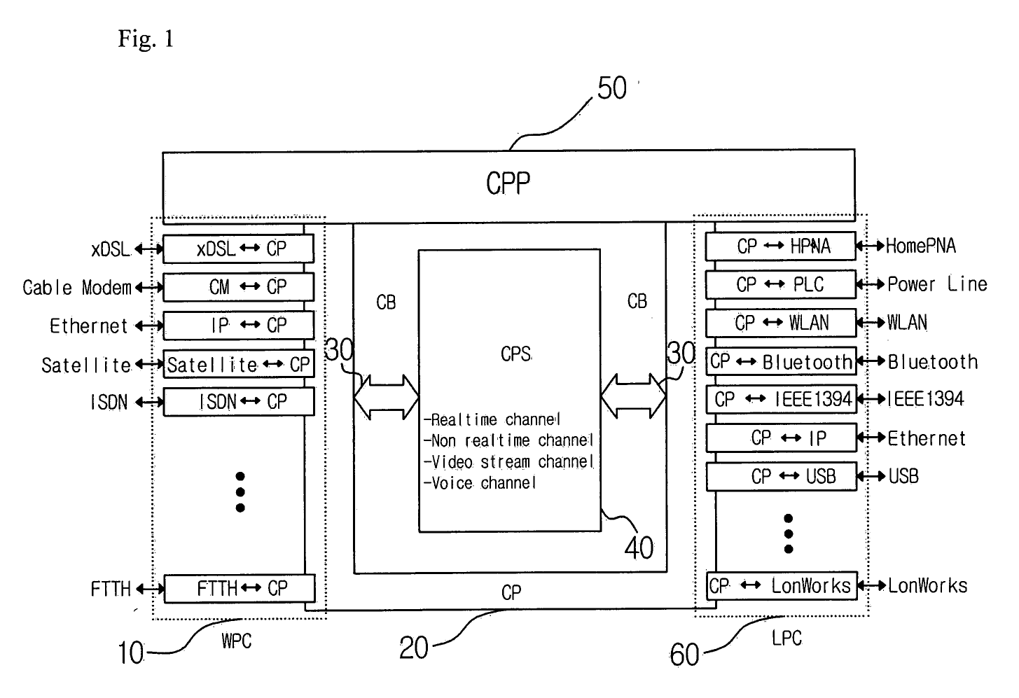

FIG. 1 is a communication system architecture designed according to the present invention. As shown in FIG. 1, a communication system of the present invention comprises a common protocol platform (hereinafter referred to as “CPP”) block (50), a WAN protocol converter (hereinafter referred to as “WPC”) block (10), a LAN protocol converter (hereinafter referred to as “LPC”) block (60), a common packet (hereinafter referred to as “CP”) block (20), a common bus (hereinafter referred to as “CB”) block (30), and a common packet switch (hereinafter referred to as “CPS”) block (40).

The WPC (10) comprises a buffer part that stores temporarily external network packets received, a conversion part that converts the packets into a form of CP, and a loader part that loads the CP on the CB to transmit to the CPS. The WPC (10) converts datagram received from an external network interface such as xDSL, Cable modem, Metro Ethernet, ISDN, CDMA, and PSTN into CP (20) datagram. On the contrary, in transmitting the datagram from an internal network to an external network, the WPC (10) converts the CP (20) datagram into external network datagram as desired.

The CP (20) is datagram having a uniform length so as to perform integrated processing of various types of external and internal network datagrams and exchange data efficiently. All external and internal network datagrams are converted into the CP (20) and processed internally.

The CB (30) is a physical interface to transmit datagram when the CP (20) datagram is transmitted to a switching block or the switched datagram is transmitted to a destination.

The CPS (40) comprises a buffer part that stores temporarily common packets received, a header translation part where a new destination address as desired is added to a header, a loader part where a header with the new destination address and existing data are loaded on the common packet, and a separate channel part based on types of traffic classes. In the CPS (40), the CP (20) entered through the CB (30) is stored temporarily, a new destination address is added to a header of the CP after the destination address is determined, and, then, the CP is transmitted. The CPS (40) is divided into various channels, i.e., separate data paths, based on types of traffic classes. The channels comprise an Internet data channel, an audio channel, a video channel, a control channel, a video stream channel, a voice channel, and so on, each of which may be designed as multi-channel.

The LPC (60) comprises a buffer part where internal packets entered are stored temporarily, a conversion part where the packets are converted into a form of CP, and a loader part where the CP is loaded on the CB to be transmitted to the CPS. In addition, the LPC (60) converts datagram received from an internal network interface such as WLAN, HPNA, PLC, LonWorks, USB, Bluetooth, IEEE1394, and so on into CP (20) datagram. On the other hand, in transmitting the datagram from an external network to an internal network, the LPC (60) converts the CP (20) datagram into an internal network datagram as desired.

The CPP (50) comprises various network protocols used for integrated processing of various types of networks. For example, there are an L2/L3 switching and routing protocol, protocols for conversion between protocols, and protocols necessary for integrated processing such as a method of address conversion, MIB for integrated management, a method of traffic priority, a scheduling method, security, quality of service (hereinafter referred to as “QoS”), and multicast.

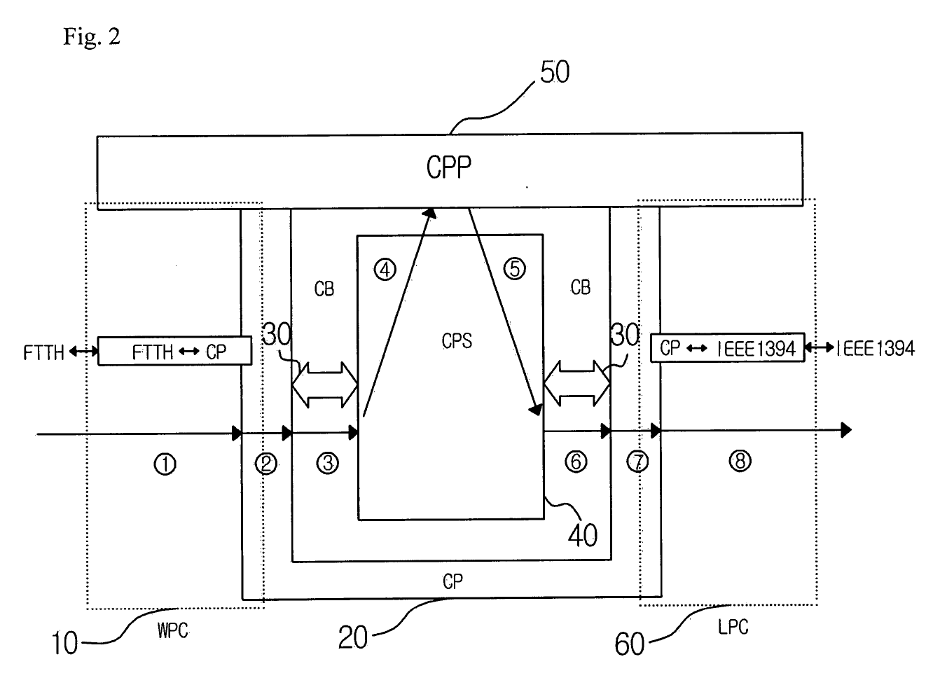

FIG. 2 illustrates a process of transmitting packets from a WAN to a LAN. As shown in FIG. 2, when data is transmitted from a WAN to a home network, packet data received from, for example, xDSL or Cable Modem using an existing protocol changes into the CP (20) via the WPC. The CP (20) has a common packet structure compatible with all packets and is transmitted into the CPS block (40) through the CB (30). The CB (30) serves as a physical interface for transmitting the CP (20) to/from the CPS block (40). The CPS block (40) adds a destination address of the data identified from the CPP block (50) to a header of the CP (20). Here, the CPP (50) performs an appropriate protocol conversion. Then, the CP (20) is loaded on the CB (30) to be transmitted to the LPC (60). The LPC (60) identifies the header of the CP (20) received, converts the CP (20) into internal network datagram corresponding to the destination address, and transmits the datagram to the internal network.

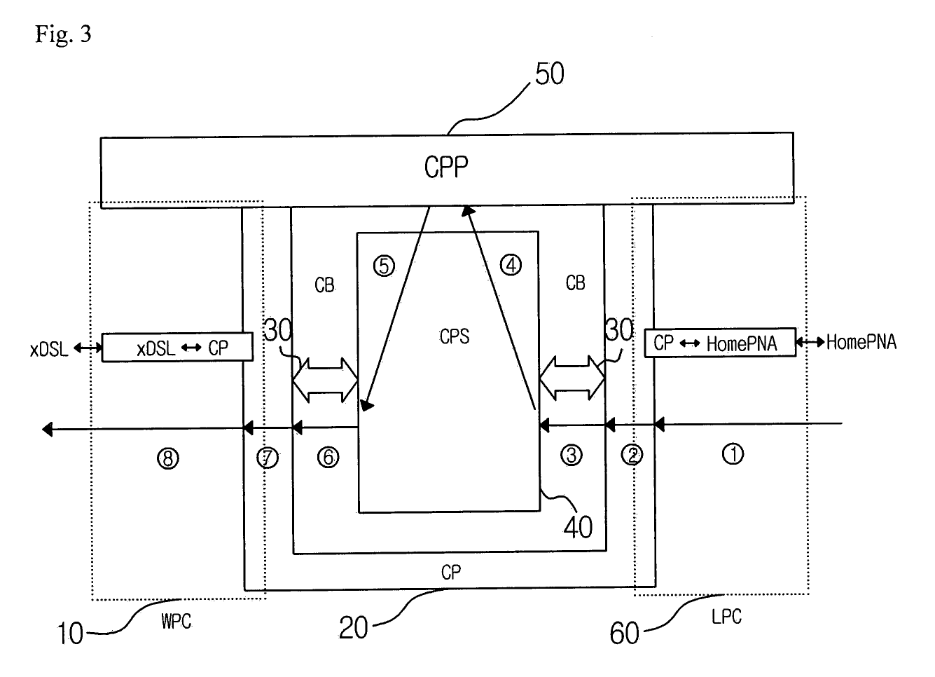

FIG. 3 illustrates a process of transmitting packets from a LAN to a WAN. As shown in FIG. 3, when data is transmitted from a home network to an external network, packet data received from existing networks such as HPNA, Ethernet, and Bluetooth is converted into the CP (20) in the LPC (60), an internal network protocol converter. Then, the CP (20) is transmitted to the CPS block (40) through the CB (30). The CB (30) serves as a physical interface for transmitting the common packet to/from the CPS block (40). The CPS block (40) adds a destination address of the data identified from the CPP block (50) to a header of the CP (20). Here, the CPP (50) performs an appropriate protocol conversion. Then, the CP (20) is loaded on the CB (30) to be transmitted to the WPC (10). The WPC (10) selects a WAN port corresponding to the header of the CP, converts the CP (20) into appropriate external network datagram, and transmits the datagram to the WAN port selected.

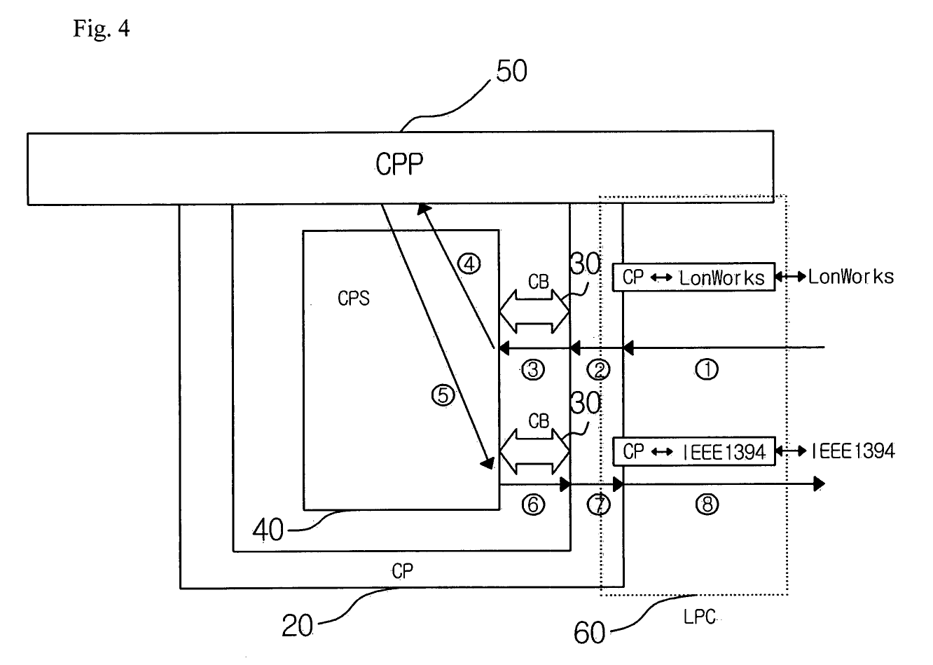

FIG. 4 illustrates a process of transmitting packets from a LAN to another LAN. As shown in FIG. 4, if there are an internal network 1 as a LonWorks network and an internal network 2 as an IEEE1394 network, in data communications between the internal network 1 and the internal network 2, data received from the internal network 1 is inputted into the LPC1, an internal network protocol converter, and converted into the CP (20). Then, the CP (20) is transmitted to the CPS block (40) through the CB (30). The CB (30) serves as a physical interface for transmitting the CP (20) to/from the CPS block (40). The CPS block (40) adds a destination address of the data identified from the CPP block (50) to a header of the CP (20). Here, the CPP (50) performs an appropriate protocol conversion. Then, the CP (20) is loaded on the CB (30) to be transmitted to the LPC2. The LPC2 selects an internal network port corresponding to the destination address after identifying the destination address added to the header of the CP, and converts the CP into appropriate internal network datagram to transmit it to the internal network port.

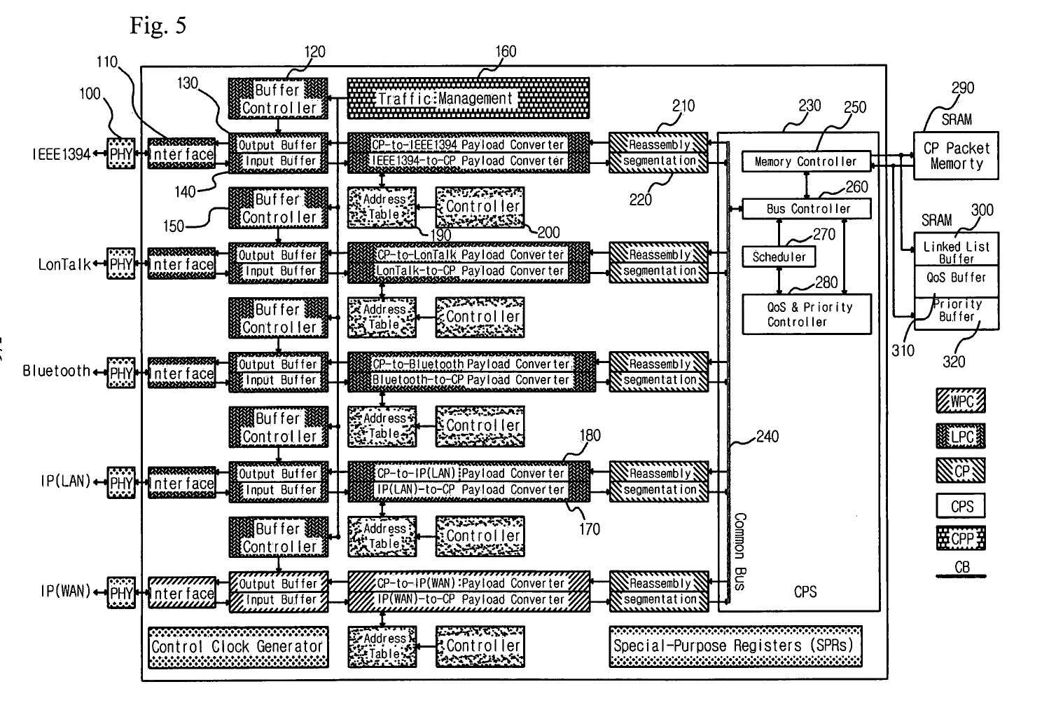

FIG. 5 is a block diagram of a chipset embodied according to the present invention. For example, when with this chipset a home IEEE1394 equipment supporting IP over IEEE1394 communicates with a PC connected to an internal or an external IP network or IEEE1394 equipment supporting other IP over IEEE1394, an interface (110) (included into WPC or PLC block) serves as a transmission path to an external PHY (physical layer) (100) chip and, on occasion, not just as a physical layer. In addition, the interface (110) converts serial data into parallel data, and transmits the parallel data to an input buffer (140).

The input buffer (140) (included into WPC block or LPC block) has a form of a typical ring buffer. A buffer controller (120) controls the input buffer (140) or an output buffer (130). In addition, the buffer controller (120) plays a role in managing pointers and transmitting to next block or discarding the data stored in buffer to work largely as a ring buffer.

A traffic management block (160) (included into CPP block) performs an internal traffic management algorithm, and transmits control signals to the buffer controller (120) so as to transmit or discard data stored in the buffer controller (120).

An anything-to-CP converter (170) (included into WPC block or LPC block) performs a packet classification algorithm, identifies a type and characteristics of the data entered, and creates a CP header containing switching information, QoS class, security, and so on. The anything-to-CP converter adds the CP header to the packet entered by means of encapsulation and, then, the packet with the CP header is transmitted to a segmentation block (220). Here, a separate address table (190) manages information such as a source address and a destination address extracted from the packet entered.

The segmentation block (220) (included into CP block) splits a payload part of the entered packet on a basis of a fixed size of 256 bytes including the header, and loads them on the CB (240). Here, segmentation information (i.e., a sequence number) is entered into the CP header. In addition, the segmentation block comprises a controller to communicate with a common bus controller (260).

The common bus (240) provides a transmission path to send packets from a plurality of nodes to a switching block, and, in reverse direction, from the switching block to the corresponding output node. Here, the common bus performs an arbitration function so that at a particular moment only one node can use the bus through communications between control blocks in the segmentation block (220) and a reassembly block (210) and the bus controller (260). The packet received through the common bus (240) is transmitted to the switching block and again to the reassembly block (210) through the common bus (240).

The packet of 256 bytes entered into CPS block is stored in an external SRAM. Here, two external SRAMs are used. One is used to store the CP packet, and the other serves as a linked list (300) of CP packet memory, a QoS buffer (310), and a priority buffer (320).

In the QoS and priority blocks, the QoS block (310) in the CPS performs a corresponding QoS algorithm; and determines a class of the packet entered to store it in a class buffer (FIFO) in regular sequence. Then, the packet is rearranged in the priority buffer (FIFO) (310) after the priority of the packet stored in the class buffer is determined. Subsequently, a scheduler (270) transmits the packet to the reassembly block (210) through the common bus (240) according to the priority sequence.

The reassembly block (210) rearranges the packet received in regular sequence and transmits it to a CP-to-anything converter (180).

Finally, the CP-to-anything converter (180) removes the CP header from the packet received, and transmits the packet to the PHY (100) of a lower node through the output buffer (130) and the interface (110).

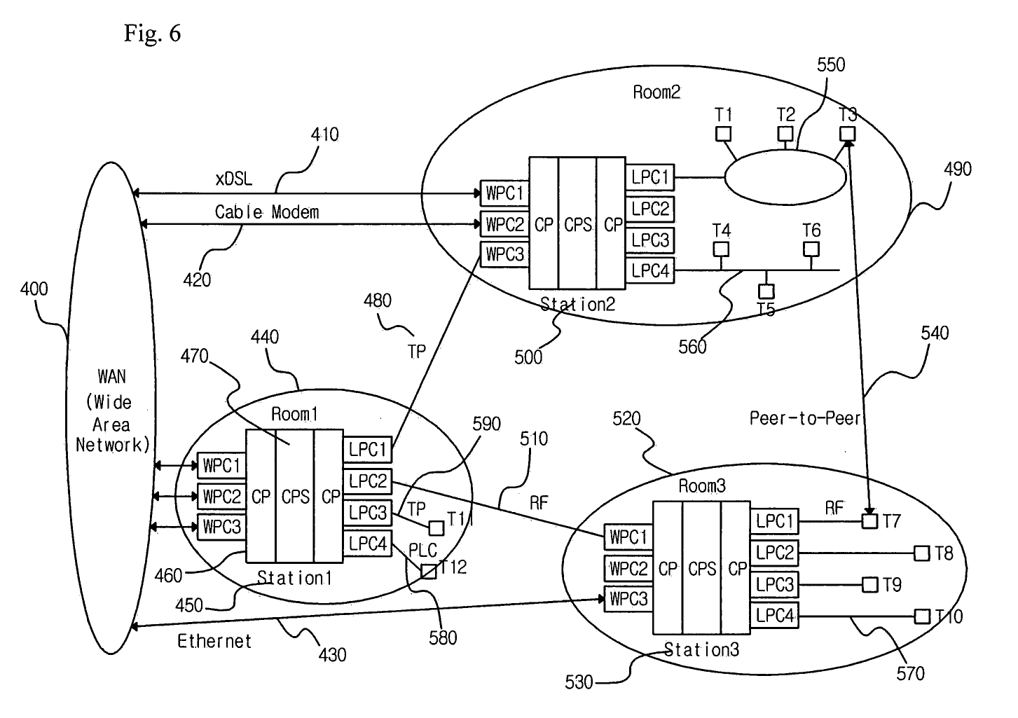

FIG. 6 is an example of various network structures embodied according to the present invention. It shows a structure of networks between stations and between stations and digital appliances. Here, the station means a home station system such as a home gateway, a home server and a set-top box, which is established using a chip of the present invention.

Referring to FIG. 6, room 1 (440), room 2 (490), and room 3 (520) may be included into one network like rooms connected to one another in a home, and may be an independent network, respectively, like first, second, and third floor in a building. In addition, station 1 (450), station 2 (500), and station 3 (530) may be included in digital appliances as terminals.

If the room 1 (440), the room 2 (490), and the room 3 (520) constitute one network, the station 1 (450) can perform integrated management for T1˜T6 terminals, which are connected to the station 2 (500) of the room 2 (490), and communicate with them by being connected with station 2 (500) by means of a TP (twisted pair) (480). In other words, T11 and T12 terminals connected directly to the station 1 of the room 1 can directly communicate with the T1˜T6 terminals and T7˜T10 terminals which are connected to the station 3 (530) of the room 3 (520). This structure makes it possible to perform data communication using any transmission media and protocol, for example, TP (590), PLC (580) and RF (510). Moreover, all of the T1˜T12 terminals can communicate with one another simultaneously. The station 1 (450) can communicate with a plurality of WANs (400) simultaneously through WPC1, WPC2 and WPC3 without connecting the station 2 (500) and the station 3 (530) to the WAN (400).

If the room 1, the room 2, and the room 3 are independent networks, respectively, the station 1 (450), the station 2 (500), and the station 3 (530) can communicate with one another, and also each station can communicate with the WAN (400) through the WPC. In addition, each station can accept all the network configurations such as a ring network (550), a star network (570), a bus network (560), and so on.

If station functions are included into terminals, the present invention can be used to integrate each terminal like the station, and make it possible to perform peer-to-peer communications (540) between digital appliances by designing the functions of the present invention in various digital appliances (i.e., included in terminals such as the T1˜T12).

### INDUSTRIAL APPLICABILITY

Thus, a system and method for integrated processing of different network protocols and multimedia traffics according to the present invention can process traffics rapidly embodied by mean of hardware, and easily perform various QoS, traffic control, and so on by designing a unified common platform with an open architecture. In addition, the present invention can be used for digital consumer devices in building networks and home networks or various digital appliances classified as Internet information appliances, and for control systems such as a home gateway, a home server, an STB, a home station and so on, which control various digital appliances and appliances for building automation and home automation connected to networks.

1. A method for integrated processing of different network protocols and multimedia traffics, comprising the steps of:
(a) converting a packet received from a wide area network into a common packet on an external network protocol converter, or converting a packet received from a local area network into a common packet on an internal network protocol converter;
(b) switching said common packet so that said common packet can be switched, bridged, and routed internally;
(c) channelizing to exchange said common packet through dedicated lines according to types of packets;
(d) loading said common packet on a common bus to transmit said common packet to/from a common packet switch; and
(e) identifying a destination address of data and performing an appropriate protocol conversion on a common packet platform, said common packet platform being able to build free topology through an address translation.

2. The method of claim 1, wherein said step (a) comprises the steps of:
storing temporarily an external or internal network packet entered in a buffer;
converting said packet into a common packet format; and
loading said common packet on said common bus to transmit said common packet to said common packet switch.

3. The method of claim 1, wherein said step (b) comprises the steps of:
storing temporarily said common packet entered in a buffer;
adding a new destination address as desired to a header; and
loading said header on said common packet to transmit said header to the new destination.

4. The method of claim 1, wherein said steps (a), (b), (d) and (e) are modularized so that each of them can be operated independently and they can interwork with one another.

5. The method of claim 1, wherein said steps (a), (b), (d) and (e) constitute a plurality of block combinations according to functions.

6. The method of claim 1, wherein said steps (a), (b), (d) and (e) are integrated on a chip so that they can work as a single chip.

7. The method of claim 1, wherein, in order to support a plug and play function, said steps (a), (b), (d) and (e) are designed as an open architecture and external networks or internal networks interwork with said common packet platform.

8. The method of claim 1, wherein, in addition to different network protocol conversions through said step (a), an overlay function toward common packet is supported.

9. A system for integrated processing of different network protocols and multimedia traffics, comprising:
a common packet having a header and data to process multi-protocol;
a common packet switch for switching, bridging, and routing said common packet internally;
a plurality of channels for exchanging said common packet through dedicated lines according to types of packets;
a common bus for transmitting said common packet to/from said common packet switch;
a common protocol platform able to build free topology through an address translation so as to perform integrated processing of different protocols, different packet formats, and so on;
an external network protocol converter for converting a packet received from a wide area network into a common packet; and
an internal network protocol converter for converting a packet received from a local area network into a common packet.

10. The system of claim 9, wherein said common packet switch comprises:
a buffer part storing temporarily said common packet entered;
a separate channel part based on types of traffic classes;
a header conversion part where a new destination address as desired is added to a header; and
a loader part loading existing data and said header with said new destination address on said common packet.

11. The system of claim 9, wherein said external network protocol converter comprises:
a buffer part storing temporarily an external network packet entered;
a conversion part converting said external network packet into said common packet; and
a loader part loading said common packet on said common bus to transmit said common packet to said common packet switch.

12. The system of claim 9, wherein said internal network protocol converter comprises:
a buffer part storing temporarily an internal network packet entered;
a conversion part converting said internal network packet into said common packet; and
a loader part loading said common packet on said common bus to transmit said common packet to said common packet switch.

13. The system of claim 9, wherein said common packet, said common bus, said common packet switch, said common packet platform, said external network protocol converter, and said internal network protocol converter are modularized so that each of them can be operated independently and they can interwork with one another.

14. The system of claim 9, wherein said common packet, said common bus, said common packet switch, said common packet platform, said external network protocol converter, and said internal network protocol converter constitute a plurality of block combinations according to functions.

15. The system of claim 9, wherein said common packet, said common bus, said common packet switch, said common packet platform, said external network protocol converter, and said internal network protocol converter are integrated on a chip so that they can work as a single chip.

16. The system of claim 9, wherein in order to support a plug and play function said common packet, said common bus, said common packet switch, said common packet platform, said external network protocol converter, and said internal network protocol converter are designed as an open architecture, and external networks or internal networks interwork with said common packet platform.
